(19) United States
(12) Patent Application Publication
(10) Pub. No.: US 2016/0139465 A1
(43) Pub. Date: May 19, 2016

(54) ALIGNMENT PLATE

(71) Applicants: BOE TECHNOLOGY GROUP CO., LTD., Beijing (CN); Hefei Xinsheng Optoelectronics Technology Co., Ltd., Anhui (CN)

(72) Inventors: Yong Yang, Beijing (CN); Weijing Liao, Beijing (CN); Huan Li, Beijing (CN)

(21) Appl. No.: 14/802,075

(22) Filed: Jul. 17, 2015

(30) Foreign Application Priority Data
Nov. 17, 2014 (CN) 201410654022.X

(51) Int. Cl. G02F 1/1337

(52) U.S. Cl. CPC G02F 1/133711; G02F 1/133707

(57) ABSTRACT

Embodiments of the present invention provide an alignment plate, and relates to the field of display technique. The alignment plate comprises a substrate layer and a protection layer covering a surface of the substrate layer; the protection layer exposes the substrate layer in predefined regions; and the substrate layer is provided with grooves in the predefined regions, and the grooves form alignment marks of the alignment plate. The alignment plate can be used for fabricating a display device, and can prevent alignment marks on the alignment plate from distorting or falling off due to rubbing.

### RELATED APPLICATION(S)

The present application claims the benefit of Chinese Patent Application No. 201410654022.X filed Nov. 17, 2014, the entire disclosure of which is incorporated herein by reference.

### FIELD OF THE INVENTION

The present invention relates to a field of display technique, and particularly to an alignment plate.

### BACKGROUND ART

Liquid crystal display is among the most widely used display devices, and comprises a liquid crystal panel and a back light module. The liquid crystal panel comprises an array substrate and a color film substrate which are aligned and assembled, and a liquid crystal layer which is filled there between.

During fabricating the liquid crystal panel, it is required to form an alignment layer on an inner surface of the substrate, so that liquid crystal molecules are arranged in a predetermined orientation. Currently, a roller transfer printing is generally applied to fabricate the alignment layer. In this printing, an alignment solution is transferred onto an alignment plate by a roller, and the alignment solution is then transferred to the surface of the substrate by the alignment plate.

During practical production, the roller-type coating leads to stretching of the alignment plate. In order to prevent adverse effects of stretching of the alignment plate from on the printing precision, it is required to arrange alignment marks on the alignment plate, so that the amount of stretching and distorting is converted into data. According to this distortion data, the coating device can automatically alter coating parameters to realize high precision printing.

In the known art, alignment marks on an alignment plate 10′ are shown in FIG. 1. In an upper of FIG. 1, a top view of the alignment plate 10′ is shown, and a cross-sectional view along a line A′-A′ is shown in a lower portion. The alignment plate 10′ comprises an upper APR™ (a photo sensitive resin which is commercially available from Asahi Kasei Corporation, and is abbreviated as APR in this specification) resin layer 102′ and a lower substrate layer 101′. The alignment marks 103′ are formed in the APR resin layer 102′. In particular, the APR resin around the alignment marks 103′ is removed to form hollowed regions, so that the alignment marks 103′ and the APR resin in the remaining regions are raised and spaced apart by the hollowed regions. In this way, two types of raised structures are formed on the alignment plate 10′, and the raised structures surrounded by the hollowed regions form the alignment marks 103′.

However, the alignment marks known in the art suffer from the following defects. In one aspect, during practical production, there is a long-term rubbing between the raised portions and the substrate surface, so that the alignment marks are distorted and thus are difficult or even impossible for the coating device to discern. In another aspect, the alignment marks are relatively small in dimension, and generally is about 0.7 mm, so that the alignment marks of raised structures tend to fall off.

### SUMMARY

Embodiments of the present invention provide an alignment plate, which can avoid or at least alleviate one or more problems in the known art. In particular, according to the alignment plate in the present invention, it is possible to prevent alignment marks on the alignment plate from distorting or falling off due to rubbing.

To this end, the following technical solutions are adopted in embodiments of the present invention.

In a first aspect, embodiments of the present invention provide an alignment plate, the alignment plate comprises a substrate layer and a protection layer covering a surface of the substrate layer; the protection layer exposes the substrate layer in predefined regions; and the substrate layer is provided with grooves in the predefined regions, and the grooves form alignment marks of the alignment plate.

Based on this, the alignment marks are designed as grooves in the substrate layer. With respect to a roller or substrate which directly contacts the alignment plate, the alignment marks are formed as a two-layer hollowed structure. In this way, it is possible to effectively prevent the alignment marks from distorting and falling off due to rubbing, thus extending the lifetime of the alignment plate and realizing high precision printing. Besides, the alignment plate is simple in structure, low in cost, and can be put into production without pre-production test.

Preferably, the grooves can be spaced from the protection layer around the predefined regions by a distance.

Based on this, the predefined regions of the protection layer has a projected area on the substrate layer which is larger than that of the alignment marks, and the alignment marks are spaced from the protection layer around the predefined regions by a distance, so that the alignment marks can be easily discerned by a coating device.

Preferably, the substrate layer can be made from an anti-stretching material.

Based on this, under long-term effects of roller-type coating, the substrate layer is not prone to distort and stretch, thus preventing the alignment marks from distorting or falling off due to rubbing.

Preferably, the protection layer can be made from a stretchable material.

Based on this, under long-term effects of roller-type coating, the protection layer is prone to distort and stretch, thus protecting the alignment marks formed in the substrate layer.

Preferably, the grooves can be arranged at centers of the predefined regions.

Based on this, the exposed substrate layer around the grooves has a uniform width, so that the coating device can easily discern the alignment marks formed by the grooves.

Preferably, the grooves can be arranged away from centers of the predefined regions.

Based on this, the grooves are simple to fabricate, and the fabricating process has a large process tolerance.

Preferably, the grooves can have a shape which is one of a circular shape, a rectangular shape, and a cross shape.

Based on this, the grooves can be formed into a circular shape, rectangular shape, or a cross shape, so as to form alignment marks with sharp borders which can be easily discerned.

Preferably, the substrate layer can have a thickness of 0.48˜0.78 mm, the protection layer can have a thickness of 2.27˜2.37 mm, and the grooves can have a depth of 0.15˜0.25 mm.

Based on this, the grooves have a depth which is less than the thickness of the substrate layer, and there is a significant height difference between the grooves and an upper surface of the substrate layer, so that the alignment marks formed by the grooves are clear and can be easily discerned.

Preferably, the protection layer can be made from resin. More preferably, the resin can be APR resin.

Preferably, the substrate layer can be made from Polyethylene Terephthalate (PET).

Preferably, the surface of the protection layer can be provided with a plurality of meshes for storing an alignment solution.

Embodiments of the present invention provide an alignment plate, the alignment plate comprises a substrate layer and a protection layer covering a surface of the substrate layer; the protection layer exposes the substrate layer in predefined regions; and the substrate layer is provided with grooves in the predefined regions, and the grooves form alignment marks of the alignment plate.

Based on this, the alignment marks are designed as grooves in the substrate layer. With respect to a roller or substrate which directly contacts the alignment plate, the alignment marks are formed as a two-layer hollowed structure. In this way, it is possible to effectively prevent the alignment marks from distorting and falling off due to rubbing, thus extending the lifetime of the alignment plate and realizing high precision printing. Besides, the alignment plate is simple in structure, low in cost, and can be put into production without pre-production test.

In a second aspect, embodiments of the present invention provide the use of the above-mentioned alignment plate during fabricating a liquid crystal display.

### BRIEF DESCRIPTION OF DRAWINGS

The specific embodiments of the present invention shall be further described in the follow text with reference to the figures and the embodiments. The following embodiments are only used for explaining more clearly the technical solution of the present invention rather than limiting the protection scope of the present invention.

FIG. 1 is a structural view of an alignment plate in the known art;

FIG. 2 is a structural view of an alignment plate in embodiments of the present invention;

FIG. 3 is another structural view of an alignment plate in embodiments of the present invention;

FIG. 4a is a structural view of alignment marks in embodiments of the present invention;

FIG. 4b is another structural view of alignment marks in embodiments of the present invention; and

FIG. 4c is yet another structural view of alignment marks in embodiments of the present invention.

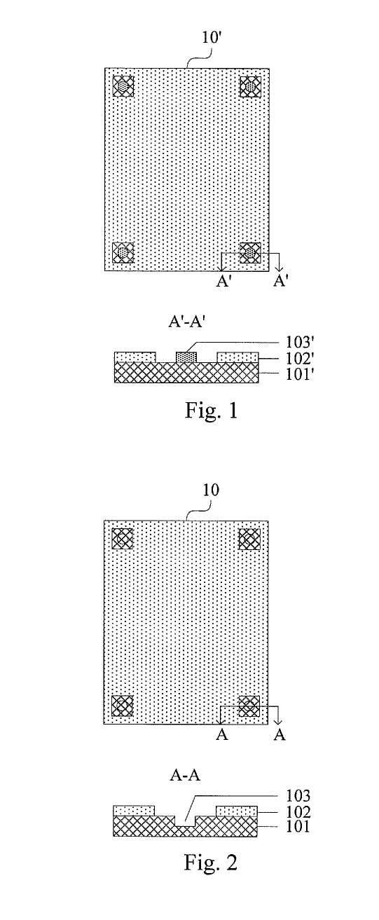

### DETAILED DESCRIPTION OF EMBODIMENTS

Several technical solutions of the present disclosure will be described in more detail below with reference to the accompanying drawings in order for those skilled in the art to be able to carry out the present disclosure. The present disclosure may, however, be embodied in many different forms and should not be construed as limited to embodiments set forth herein. These embodiments do not limit the present disclosure, but the present disclosure is only limited by the appended claims.

The reference numerals in drawings are explained as follow: 10′, 10—alignment plate; 101′, 101—substrate layer; 102′, 102—(APR) resin layer; 103′, 103—alignment marks.

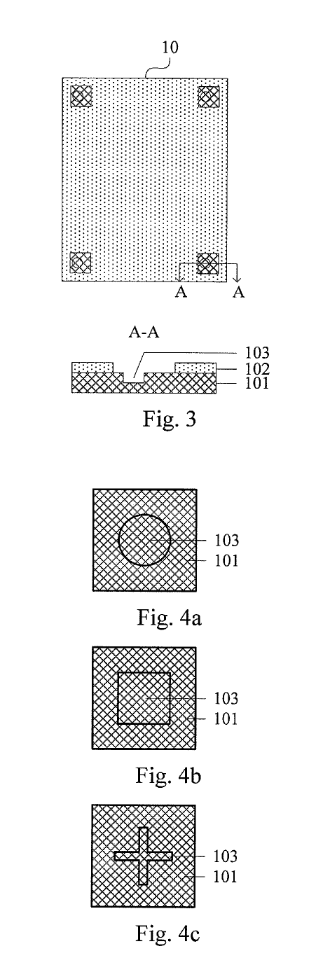

Reference is made to FIGS. 2-3, wherein upper portions of FIGS. 2-3 illustrate top views of an alignment plate 10, and lower portions illustrate cross-sectional views along a line A-A. As shown in FIG. 2 and FIG. 3, in an embodiment of the present invention, the alignment plate 10 comprises a substrate layer 101 and a protection layer 102 covering a surface of the substrate layer 101. The protection layer 102 exposes the substrate layer 101 in predefined regions. In the predefined regions, the substrate layer 101 is provided with grooves, which form alignment marks 103 of the alignment plate 10. The substrate layer 101 around the grooves is exposed. The substrate layer 101 can be made from an anti-stretching material, and the protection layer 102 can be made from a stretchable material. In the following, the present invention is described in a manner that the protection layer 102 is a resin layer 102.

It is noted that, firstly, the predefined regions refer to regions where alignment marks 103 are arranged, and the predefined regions has a projected area on the substrate layer 101 which should be larger than that of the alignment marks 103 on the substrate layer 101.

Secondly, in embodiments of the present invention, grooves formed in the substrate layer 101 are alignment marks 103 of the alignment plate 10. Since the alignment marks 103 are used to provide identification for a coating device, the alignment marks 103 should be spaced from the resin layer 102 which is arranged around and raised with respect to the predefined regions, so that they can be discerned by the coating device.

Based on this, the resin layer 102 can expose the substrate layer 101 in the predefined regions, and the substrate layer 101 around the grooves is exposed. In this way, it is ensured that the alignment marks 103 are not flush with the resin layer 102 beyond the predefined regions, so that the alignment marks 103 can be easily discerned.

Thirdly, the substrate layer 101 is made from an anti-stretching material. Particularly, this indicates that, under long-term effects of roller-type coating, the substrate layer 101 is not prone to distort stretch. The resin layer 102 is made from a stretchable material. Particularly, this indicates that, under long-term effects of roller-type coating, the resin layer 102 is prone to distort and stretch.

Embodiments of the present invention provide an alignment plate 10, which comprises the substrate layer 101 and the resin layer 102 covering the surface of the substrate layer 101. The resin layer 102 exposes the substrate layer 101 in predefined regions. The substrate layer 101 is provided with grooves in the predefined regions, thus forming alignment marks 103 of the alignment plate 10. The substrate layer 101 around the grooves is exposed. The substrate layer 101 can be made from an anti-stretching material, and the protection layer 102 can be made from a stretchable material.

Based on this, the alignment marks 103 are designed as grooves in the substrate layer, and are located within the substrate layer 101 with excellent anti-stretching property. With respect to a roller or substrate which directly contacts the alignment plate 10, the alignment marks 103 are formed as a two-layer hollowed structure. In this way, it is possible to effectively prevent the alignment marks 103 from distorting and falling off due to rubbing, thus extending the lifetime of the alignment plate and realizing high precision printing. Besides, the alignment plate 10 is simple in structure, low in cost, and can be put into production without pre-production test.

Based on this, as shown in FIG. 2, the grooves are preferably arranged at centers of the predefined regions. Namely, the exposed substrate layer 101 around the grooves has a uniform width.

In case the grooves have a shape different from that of the predefined regions and both the grooves and the predefined regions have regular and symmetrical shapes, the grooves have centers coinciding with those of the predefined regions. For example, the grooves can have a circular shape, the predefined regions can have a rectangular shape, and the circular shape has a center which coincides with a center of the rectangular shape.

Alternatively, in case the grooves have the same shape as that of the predefined regions, the exposed substrate layer 101 around the grooves has a uniform width. For example, both the grooves and the predefined regions can have a rectangular shape, and there is always a constant distance between a side of the grooves and a corresponding side of the predefined regions.

In this way, the distance between sides of the grooves and sides of the predefined regions is always uniform and symmetrical. When the coating device captures the alignment marks 103, a contrast between the resin layer 102 and the substrate layer 101 is clear, and a contrast between the substrate layer 101 and the grooves is clear, so that the alignment marks 103 can be discerned easily. In this way, an error for the coating device to discern the alignment marks can be effectively reduced, and the accuracy for discerning can be improved.

As shown in FIG. 3, the grooves can be arranged away from centers of the predefined regions.

Base on the foregoing, as shown in FIGS. 4a-4c, the grooves can optionally have a shape which is one of a circular shape, a rectangular shape, and a cross shape.

Here, the grooves can be arranged at centers of the predefined regions, so that the distance between sides of the grooves and sides of the predefined regions is always uniform and symmetrical.

Of course, the grooves can also have other regular shapes or have irregular shapes, and the grooves of the present invention are not limited in this regard.

Based on this, in embodiments of the present invention, the grooves have a circular shape, a rectangular shape, or a cross shape, so that the alignment marks 103 have clear sides. In this way, the alignment marks 103 can be easily discerned, and high precision printing is enabled.

Further, the substrate layer 101 can have a thickness of 0.48˜0.78 mm, the resin layer 102 can have a thickness of 2.27˜2.37 mm, and the grooves can have a depth of 0.15˜0.25 mm.

Since the grooves are arranged in the substrate layer 101, the depth the grooves should be less than the thickness of the substrate layer 101. In addition, it is required that there is a significant height difference between the grooves and an upper surface of the substrate layer 101, so that the grooves are clear and easy to discern.

Based on the foregoing, the resin layer 102 can optionally be an APR resin layer, and the substrate layer 101 can be a PET substrate layer. Here, the surface of the APR resin layer is provided with a plurality of meshes for storing an alignment solution.

It will be apparent to those skilled in the art that various modifications and variations can be made in the present invention without departing form the spirit or scope of the invention. Thus, it is intended that the present invention cover the modifications and variations of this invention provided they come within the scope of the appended claims and their equivalents.

What is claimed is:

1. An alignment plate comprising: a substrate layer and a protection layer covering a surface of the substrate layer,
wherein the protection layer exposes the substrate layer in predefined regions; and
wherein the substrate layer is provided with grooves in the predefined regions, and the grooves form alignment marks of the alignment plate.

2. The alignment plate of claim 1, wherein the grooves are spaced from the protection layer around the predefined regions by a distance.

3. The alignment plate of claim 1, wherein the substrate layer is made from an anti-stretching material.

4. The alignment plate of claim 1, wherein the protection layer is made from a stretchable material.

5. The alignment plate of claim 1, wherein the grooves are arranged at centers of the predefined regions.

6. The alignment plate of claim 1, wherein the grooves are arranged away from centers of the predefined regions.

7. The alignment plate of claim 1, wherein the grooves have a shape which is one of a circular shape, a rectangular shape, and a cross shape.

8. The alignment plate of claim 1, wherein the substrate layer has a thickness of 0.48˜0.78 mm, the protection layer has a thickness of 2.27˜2.37 mm, and the grooves have a depth of 0.15˜0.25 mm.

9. The alignment plate of claim 1, wherein the protection layer is made from resin.

10. The alignment plate of claim 9, wherein the resin is APR resin.

11. The alignment plate of claim 1, wherein the substrate layer is made from Polyethylene Terephthalate.

12. The alignment plate of claim 1, wherein the surface of the protection layer is provided a plurality of meshes for storing an alignment solution.

13. The use of the alignment plate of claim 1 during fabricating a liquid crystal display.
